(19) United States
(12) Patent Application Publication
(10) Pub. No.: US 2021/0186041 A1
(43) Pub. Date: Jun. 24, 2021

(54) USE OF MICRO- AND NANO-BUBBLES IN LIQUID PROCESSING

(71) Applicant: Kansas State University Research Foundation, Manhattan, KS (US)

(72) Inventors: Jayendra Amamcharla, Manhattan, KS (US); Bingyi Li, Manhattan, KS (US); Zhe Liu, Manhattan, KS (US)

(21) Appl. No.: 16/071,385

(22) PCT Filed: Jan. 20, 2017
(86) PCT No.: PCT/US17/14272

§ 371 Date: Jul. 19, 2018

Related U.S. Application Data
(60) Provisional application No. 62/281,464, filed on Jan. 21, 2016.
(60) Provisional application No. 62/378,403, filed on Aug. 23, 2016.

(51) Int. Cl. A23C 9/152; A23C 9/13; A23G 9/46; A23L 2/54; A23L 33/19

(52) U.S. Cl. CPC A23C 9/1524; A23C 9/1307; A23G 9/46; A23C 2240/20; A23L 33/19; A23C 2210/30; A23L 2/54

(57) ABSTRACT

Methods of reducing the viscosity of a liquid flowing through process equipment by introducing into the liquid a quantity of micro- and/or nano-sized bubbles are disclosed. In particular embodiments, the liquid comprises a plurality of very fine charged particles, such as proteins. The bubbles that are introduced into the liquid induce within the liquid/bubble interface a charge that is of the same polarity to that of the charged particles dispersed within the liquid. Liquid products comprising a plurality of micro- and/or nanobubbles are also disclosed.

### RELATED APPLICATION

The present application claims the priority benefit of U.S. Provisional Patent Application Ser. No. 62/378,403, filed Aug. 23, 2016, and U.S. Provisional Patent Application Ser. No. 62/281,464, filed Jan. 21, 2016, both are hereby incorporated by reference in their entireties.

### BACKGROUND OF THE INVENTION

### Field of the Invention

The present invention generally pertains to methods of reducing the viscosity of a liquid flowing through process equipment by introducing into the liquid a quantity of micro- and/or nano-sized bubbles. In particular embodiments, the liquid comprises a plurality of very fine charged particles, such as proteins. The bubbles that are introduced into the liquid induce within the liquid/bubble interface a charge that is of the same polarity to that of the charged particles dispersed within the liquid. Applications for the present invention include the concentration of milk proteins within a liquid dairy product such as through the use of an evaporation or membrane filtration system and the preparation of milk protein powder through spray drying of a liquid dairy product.

### Description of the Prior Art

In many liquid handling processes, particularly those involving more viscous liquids, the capital cost associated with pumps and the energy costs associated with operating those pumps can be significant. The more viscous the liquid, the more horsepower is required to flow the liquid through the liquid handling equipment. This results in the requirement for larger pumps and greater energy demand. Therefore, being able to reduce liquid viscosity may result in a reduction in both capital and operational costs. However, reducing the viscosity of the liquid often requires the addition of flow additives or diluents, which can undesirably affect other characteristics of the liquid.

The benefits of viscosity reduction may be realized, for example, in the concentration of dairy products. For example, milk powder may be produced from skim milk by first concentrating the skim milk in an evaporator under vacuum. Typically, the milk is concentrated within the evaporator to a total solids content of approximately 50%. The concentrated skim milk is then dried using a spray dryer. As the milk is concentrated within the evaporator, the viscosity of the liquid increases. This increase in viscosity makes it very difficult to concentrate the milk any further within the evaporator. Therefore, approximately half of the moisture contained within the original skim milk is required to be removed in the spray dryer. If the viscosity of the skim milk undergoing concentration within the evaporator can be reduced, more moisture can be removed from the milk in the evaporator. Consequently, the amount of moisture needed to be removed in the spray dryer is reduced. Thus, a smaller spray dryer may be required and/or the energy requirements of the spray dryer can be reduced leading to the more cost-effective production of milk powder.

Membrane filtration has been adapted for use in the dairy industry to serve different purposes. Ultrafiltration (UF) typically is used for concentration and standardization of milk proteins that are intended for production of several highly value-added products such as milk protein concentrate (MPC), milk protein isolate (MPI), and also cheese and yogurt. In the application of UF, water, soluble minerals, and lactose pass through membranes thereby concentrating whey proteins and casein to achieve a final protein concentration. As concentration increases, the retentate viscosity increases and fouling builds up on the membranes. In a UF process with constant transmembrane pressure, the permeate flux also decreases as does process efficiency.

### SUMMARY OF THE INVENTION

According to one embodiment of the present invention there is provided a method of reducing the viscosity of a liquid carrying dissolved or suspended solid particles having an electrostatically charged surface. The method comprises the step of introducing a plurality of gaseous bubbles into the liquid. The gaseous bubbles generally have an average diameter of less than 40 microns and induce an electrostatic charge in the interface between the liquid and gaseous bubbles that is of the same polarity as the electrostatic charge carried by the surface of the solid particles.

According to another embodiment of the present invention there is provided a method of concentrating a liquid dairy product. A plurality of gaseous bubbles is introduced into the liquid dairy product. The gaseous bubbles have an average diameter of less than 40 microns. Then at least a portion of the water is removed from the liquid dairy product so as to form a concentrated dairy product. In particular embodiments, the step of removing water from the liquid dairy product is carried out within an evaporator or within a membrane filtration system.

In still another embodiment according to the present invention there is provided a dairy product infused with a plurality of gaseous bubbles having an average diameter of less than 40 microns.

In yet another embodiment there is provided a milk protein powder that is formed by a process comprising the steps of introducing a plurality of gaseous bubbles into a liquid dairy product, the gaseous bubbles having an average diameter of less than 40 microns and passing the liquid dairy product containing the plurality of gaseous bubbles through a spray dryer to form the concentrated milk protein powder.

### BRIEF DESCRIPTION OF THE DRAWINGS

FIG. 1 schematically depicts the casein micelle;

FIG. 2 is graph depicting the average chord length distribution of bubbles in a liquid medium such as water or skim milk as measured using a focused beam reflectance measurement system;

FIG. 3 is a schematic illustration of an exemplary apparatus for introducing gaseous bubbles into a liquid;

FIG. 4 is a schematic illustration of a single-effect falling-film evaporator that may be used in one embodiment of the present invention;

FIG. 5 is a schematic illustration of a spray dryer that may be used in one embodiment of the present invention;

FIG. 6 is a graph of the effect of introducing gaseous bubbles on viscosity of a condensed milk product having a total solids content of 54%;

FIG. 7 is a graph of the effect of introducing gaseous bubbles on viscosity of a milk product having a total solids content of 15%;

FIG. 8 is a graph of the effect of introducing gaseous bubbles on viscosity of a milk product having a total solids content of 17%;

FIG. 9 is a graph of the effect of introducing gaseous bubbles on viscosity of a milk product having a total solids content of 20%;

FIG. 10 is a graph of the effect of introducing gaseous bubbles on viscosity of a Greek-style yogurt product;

FIG. 11 is a graph and table of the effect of introducing gaseous bubbles on viscosity of a nonfat yogurt product;

FIG. 12 is a schematic illustration of an exemplary membrane processing system in accordance with the present invention;

FIG. 13 is a schematic illustration of an exemplary spray drying system in accordance with the present invention;

FIG. 14 are SEM micrographs of a spray-dried milk protein powder produced via the injection of micro- and nanobubbles into the spray dryer feed; and

FIG. 15 are SEM micrographs of a control spray-dried milk protein powder in which the spray dryer feed was not injected with micro- and nanobubbles.

### DETAILED DESCRIPTION OF THE PREFERRED EMBODIMENT

Gaseous micro- and nanobubbles introduced within liquids have been found to possess unique characteristics. For example, unlike larger-sized bubbles, which escape from a liquid medium relatively quickly, micro- and nanobubbles are much more stable and can remain dispersed within the liquid medium for longer periods of time. It has been discovered that micro- and nanobubbles can affect certain physical characteristics of the liquid into which they are introduced. As explained below, it has been discovered that micro- and nanobubbles can have the effect of lowering the viscosity of the liquid into which they have been introduced, especially liquids containing suspended charged particles.

According to certain embodiments of the present invention, the liquid into which the micro- and/or nanobubbles are introduced can be substantially any liquid, especially aqueous liquids. However, in particular embodiments, the liquid carries dissolved or suspended solid particles having an electrostatically charged surface, such as protein molecules. As explained in greater detail below, in certain embodiments, the gaseous bubbles induce an electrostatic charge in the interface between the liquid and gaseous bubbles that interacts with the electrostatically charged surface of the suspended solid particles. While not wishing to be bound by any particular theory, it is believed that this interaction between the charged interface and charged particles assists in the observed viscosity reduction characteristics for the liquid.

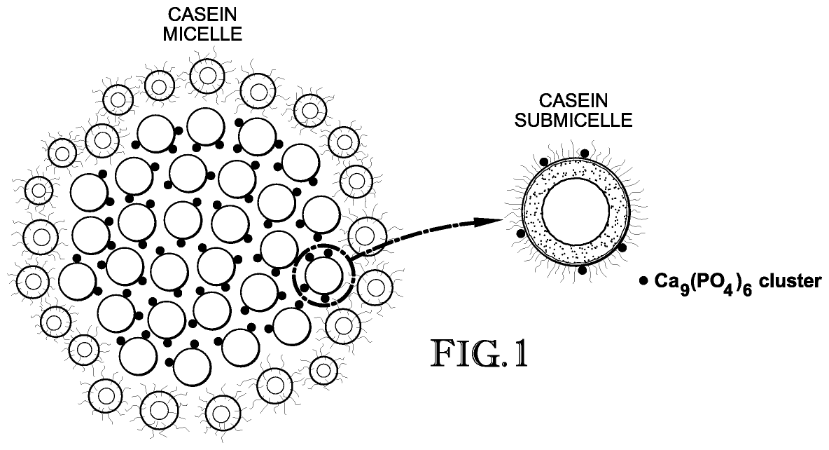

In certain embodiments, the aqueous liquid that comprises the suspended solid particles is a dairy product such as milk, milk concentrates or yogurt, and the solid particles comprise casein particles. As illustrated in FIG. 1, casein is generally found in milk as a suspension of particles called casein micelles, which have a hydrophobic core surrounded by a plurality of calcium phosphate clusters. The isoelectric point of casein is 4.6. Since the pH of milk is generally about 6.6, casein has a negative charge in milk.

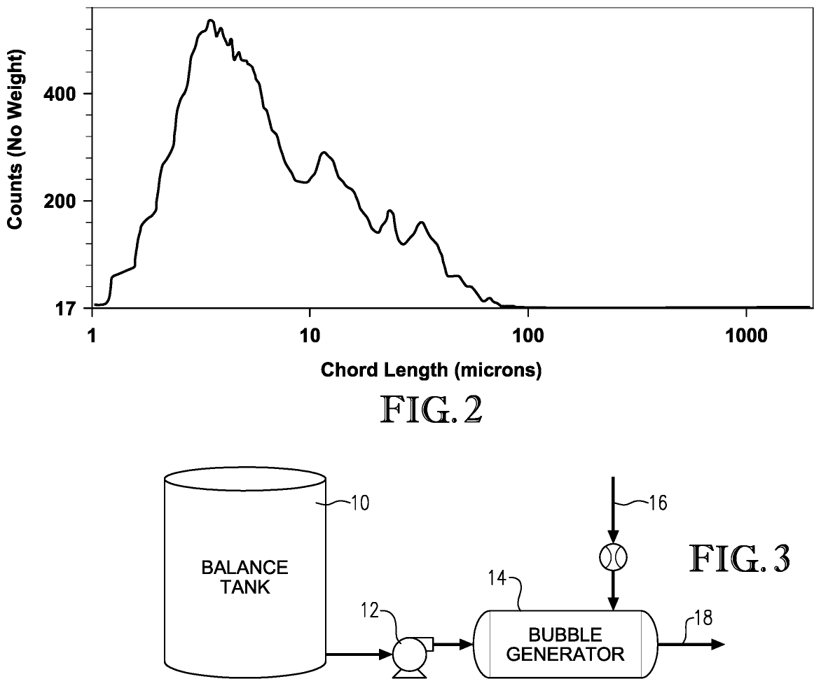

The gaseous bubbles introduced into the liquid generally have an average diameter of less than 40 microns, less than 20 microns, less than 10 microns, or less than 1 micron. In particular embodiments, the gaseous bubbles have an average diameter of from about 100 nm to about 30 microns, from about 200 nm to about 5 microns, or from about 300 nm to about 1 micron. FIG. 2 illustrates an exemplary chord length distribution in a liquid medium such as water or skim milk as measured using a focused beam reflectance measurement system. In certain embodiments, the gaseous bubbles are sized so as to be of the same or similar order of magnitude as the diameter of the solid particles suspended within the liquid. In particular embodiments, the gaseous bubbles introduced into the liquid induce an electrostatic charge in the interface between the liquid (e.g., water) and gaseous bubbles that is of the same polarity as the electrostatic charge carried by the surface of the solid particles. In the case of a milk product, as noted above casein generally exhibits a negative charge. The gaseous bubbles introduced into the milk product induce a negative electrostatic charge in the interface between the milk product and gaseous bubbles. The gaseous bubbles provide a buffer between the casein particles helping to keep the particles separated and from aggregating.

In certain embodiments of the present invention, the gaseous bubbles are introduced into the liquid using a bubble generator or diffuser configured to emit bubbles of the desired diameter. An exemplary apparatus for introducing the micro- and nanobubbles into a liquid is illustrated in FIG. 3. The liquid is contained within a tank 10 and then pumped by pump 12 through a bubble generating section 14. Section 14 may be a section of conduit or vessel in which a diffuser or bubble generating device is located. A flow of gas 16, such as air, is directed into bubble generating section 14. In certain embodiments, the liquid becomes saturated with the gaseous bubbles, but this need not always be the case and bubbles can be introduced to a point that is less than the saturation point for the particular liquid. In certain embodiments, the concentration of the bubbles within the liquid is from about 1×10⁷ to about 1×10⁹ bubbles/ml, or from about 1×10⁸ to about 2×10⁷ bubbles/ml. The gas-infused liquid 18 is then carried away from section 14.

A number of gases can be used in the generation of the micro- and/or nanobubbles. In certain embodiments, the gas is selected from the group consisting of air, nitrogen, oxygen, carbon dioxide, and combinations thereof. While it is possible to employ other gases and still obtain the viscosity reduction of the liquid, the foregoing gases are particularly preferred for used with food products as they are generally considered safe for human and animal consumption. In addition, the use of gaseous bubbles achieves a reduction in viscosity without the use of chemical additives and avoids the labeling issues associated with the use of these types of additives.

The addition of the bubbles produces a dairy product that is infused with a plurality of gaseous bubbles having an average diameter of less than 40 microns. As illustrated in the examples, below, the dairy product exhibits unique physical characteristics, such as a significantly lower viscosity as compared with the same dairy product that has not been infused with the gaseous bubbles. In certain embodiments, the dairy product is saturated with the gaseous bubbles, however, this need not always be the case. In certain embodiments, the dairy product including the gaseous bubbles comprises water at a level of from about 40% to about 90% by weight, from about 45% to about 88% by weight, or from about 50% to about 70% by weight. In other embodiments, the dairy product including the gaseous bubbles comprises a total solids content of from about 10% to about 60% by weight, from about 12% to about 55% by weight, or from about 30% to about 50% by weight.

In addition to being used to reduce the viscosity of the liquid, and especially in the context of food or beverage products, it has been discovered that introducing the plurality of gaseous bubbles can improve or provide a different mouthfeel for the product. Further, in the context of a yogurt product, incorporation of the micro- and/or nanobubbles reduces the viscosity and makes yogurt drinkable at higher protein contents.

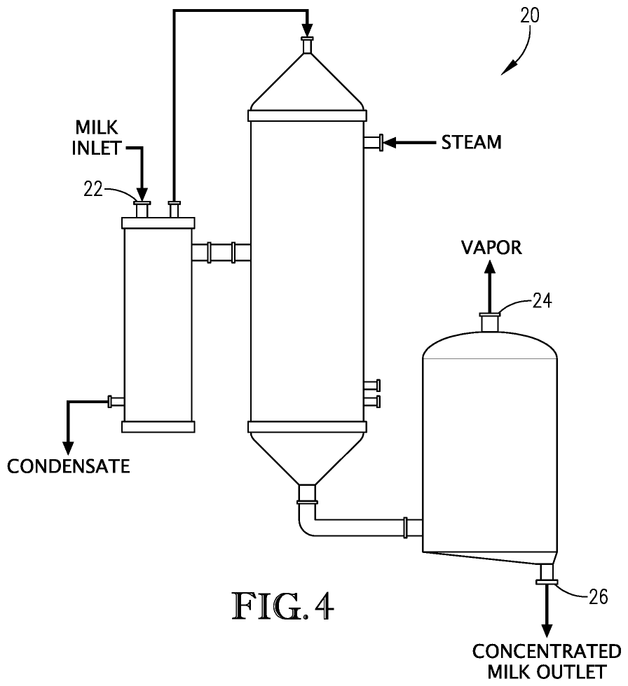

The reduction in viscosity characteristic is particularly useful in applications pertaining to the concentration of liquids, especially dairy products. In one embodiment, gaseous bubbles can be added to a milk product that is fed to an evaporator. FIG. 4 illustrates an exemplary, single-effect evaporator system 20. The liquid containing the gaseous bubbles is introduced into the milk inlet 22. It is also within the scope of the present invention for the gaseous bubbles to be introduced into the dairy product within the evaporator itself. Steam is supplied to evaporator 20 and provides the energy to evaporate at least a portion of the water from the liquid dairy product to form a concentrated dairy product. The evaporated moisture is removed from the evaporator system 20 via outlet 24 and the concentrated dairy product is removed via outlet 26. In certain embodiments, the milk product fed to the evaporator system 20 may have a water content of from about 85% to about 95% by weight. The concentrated dairy product removed via outlet 24 may have, in certain embodiments, a water content of from about 40% to about 60% by weight.

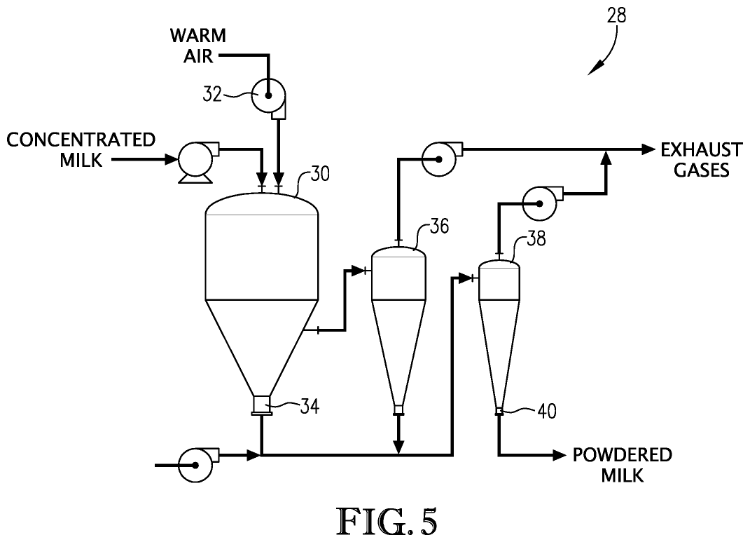

In certain embodiments, the concentrated dairy product removed via outlet 26 may be directed toward a downstream spray drying assembly 28, such as the assembly illustrated in FIG. 5, in order to form a powdered dairy product. Within assembly 28, the concentrated milk is sprayed within a cyclone dryer 30 and contacted with warm air from blower 32 so as to remove additional moisture from the milk product and eventually form a dry powder product that is removed via outlet 34. Secondary cyclone 36 removes milk particles entrained within the drying air stream. Final cyclone 38 removes additional moisture from the powder product and the finished powder is recovered from outlet 40.

The concepts of the present invention also may be applied to membrane processing of dairy products, especially ultrafiltration (UF) processing. In ultrafiltration processing, the proteins present in the milk are rejected by the filter while water, lactose, and various minerals are permitted to pass through. Gradually, the protein concentration within the retentate rises and the overall flux across the filter membrane decreases. In these embodiments, the micro- and/or nanobubbles are continuously injected into milk and/or milk retentate in-line prior to the membrane filtration unit. Injection of the bubbles has been shown to increase UF flux and decrease overall processing time when concentrating milk to the same concentration factor (CF). The whey protein concentration in the retentate from bubble-injected UF processing is increased, and in some embodiments doubled, as compared to the controls. It is noted that other types of membrane processing may be performed, such as microfiltration, nanofiltration, and reverse osmosis, and the present invention may be applicable to any of these membrane processes.

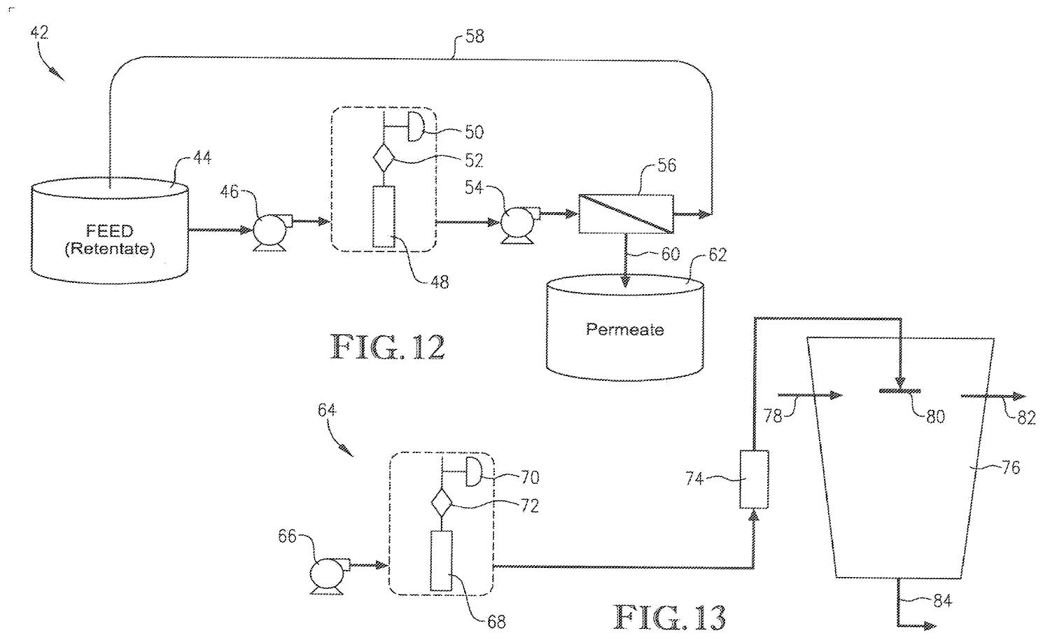

FIG. 12 illustrates an exemplary ultrafiltration system 42 according to the present invention. The feed, for example skim milk, is drawn from storage vessel 44 by a first pump 46. A bubble injector 48 is located downstream from pump 46. Injector 48 is fed with a source of pressurized gas (e.g., air) through valve 50 and flow meter 52. A second pump 54 is located downstream from injector 48 and operates to ensure a constant transmembrane pressure within filter module 56. The filter module retentate, represented by stream 58, can be recycled to the feed storage vessel 44 for subsequent passes through the filter module 56 thereby gradually increasing the protein concentration thereof. The filter module permeate, represented by stream 60, is directed toward a permeate storage vessel 62 to await further processing or disposal. As illustrated in Example 4, the introduction of micro- and/or nanobubbles into the feed to the ultrafiltration module improves the overall flux through the filter membrane as compared with an otherwise identical feed that did not include the bubbles. As a result, the concentration factor (CF) (the ratio of the feed to the concentrate) is also improved relative to the control. In certain embodiments, the CF can range up to 4:1, or even up to 5:1.

In certain embodiments, the amount of bubbles introduced into the liquid undergoing membrane separation, as determined by volume flow rate, has been shown to possess some degree of criticality. If too few bubbles are introduced, enhanced flux is not observed. If too great of a quantity of bubbles are introduced, the bubbles can cover the surface of the membrane thereby decreasing its surface area that is available to perform the separation. Therefore, in certain embodiments, it has been discovered that an optimal ratio of gas flow rate (passing through the injector) to liquid feed flow rate is between about 0.001 to about 0.25, or from about 0.005 to about 0.125, or from about 0.05 to about 0.1.

In certain embodiments, following ultrafiltration, the retentate can be sent to an evaporator or nanofiltration unit to remove water. The evaporator can be configured similarly to system 20 described above, and the nanofiltration unit can be configured similarly to ultrafiltration system 42. Following the removal of this additional water, if performed, the protein-enriched material can be sent to a spray dryer in order to generate a milk protein powder material. In certain embodiments, the milk protein powder material may be milk protein concentrate (e.g., whey protein concentrate, between 40-89% by weight protein, dry basis), milk protein isolate (e.g., whey protein isolate, minimum 90% by weight protein, dry basis), or other milk powder. It has been discovered that the introduction of micro- and/or nanobubbles into the feed to the spray dryer can produce a powder material with highly beneficial characteristics as compared to a powder prepared through a traditional spray drying process.

In order for the functional characteristics of the milk protein powder materials to be realized in the manufacture of food products, the powders must be completely dispersed and dissolved in water. However, concentrated milk protein powders generally exhibit low solubility and dispersibility, requiring long rehydration times. Additionally, shelf life for concentrated milk protein powders is a concern as the solubility of the powders decreases during storage. It has been discovered that the introduction of micro- and/or nanobubbles into the spray dryer feed can improve these solubility characteristics of the finished powder product, as well as improve the performance and efficiency of the spray dryer unit.

An exemplary spray drying unit 64 is illustrated in FIG. 13. The feed is delivered to unit 64 by a feed pump 66. A bubble injector 68 is located downstream from pump 66. Injector 68 is fed with a source of pressurized gas (e.g., air) through valve 70 and flow meter 72. A high-pressure pump 74 is located downstream from injector 68 and is operable to deliver the spray dryer feed to spray dryer 76 at a constant pressure. Within spray dryer 76, the feed is dispersed into a hot air stream 78 via one or more spray nozzles 80. Moisture is removed from the feed and removed from the spray dryer via stream 82. The powder product is recovered from the spray dryer via stream 84.

Spray drying unit 64 is operable to create pores and capillaries within the microstructure of the resulting powder particles due to the rapid expansion and liberation of the dissolved bubbles within the feed upon contact with the hot air within the spray dryer. These capillaries and pores are characteristics of a coarse network of casein micelles that are lined by short bridges and direct micelle-micelle interactions. This structure gives the powder particles improved wettability and solubility.

The improved wettability and solubility permit the protein powder to be used more efficiently in manufacture of protein-enriched liquids. As the protein powder particles rapidly disperse by disintegrating into smaller and smaller particles, fouling of process equipment, such as filters, is avoided. Moreover, the incorporation of bubbles into the spray dryer feed tends to reduce the viscosity of the feed permitting the use of feed streams with higher total solids content, thereby reducing the moisture levels to be removed within the spray dryer and costs associated with spray dryer operation.

In certain embodiments, the milk protein powders produced according to this method tend to have a lower bulk and tapped densities than milk protein powders produced by a similar process without the introduction of micro- and/or nanobubbles.

### EXAMPLES

The following examples illustrate the concepts of viscosity reduction in liquids resulting from the incorporation of micro- and nano-bubbles. It is to be understood, however, that these examples are provided by way of illustration and nothing therein should be taken as a limitation upon the overall scope of the invention.

### Example 1

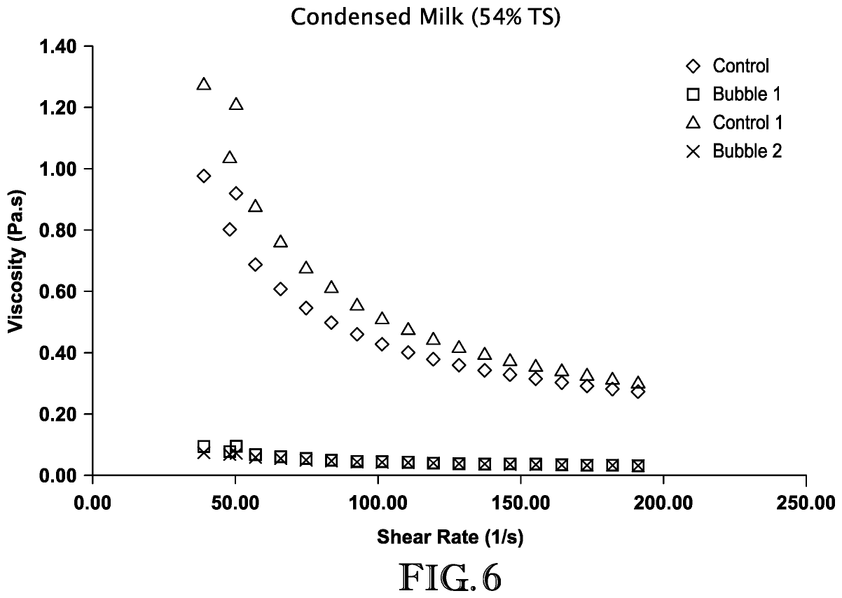

In order to demonstrate the concept that viscosity of a liquid dairy product can be lowered through the introduction of gaseous nanobubbles, gaseous nanobubbles were introduced into a quantity of a commercially available condensed milk product having a total solids content of approximately 54% by weight. The nanobubbles were introduced using the apparatus illustrated in FIG. 3. Condensed milk with 54% total solids was pumped using a diaphragm liquid transfer pump (KNF Liquiport, NJ, USA) through a venturi gas injector and subsequently collected into a separate sample container. The venture gas injector acts as a device to incorporate air as micro/nano-size bubbles into the milk product. A preferred injector is commercially available from Hydra-Flex, Inc. However, any of a variety of injectors could be used to incorporate air into the milk product. The sample without incorporated bubbles was also pumped through the pump without the gas injector and used for comparison. The viscosity of the condensed milk product with and without nanobubbles was measured twice using a stress controlled rheometer (ATS Rheosystems, NJ) at various sheer rates. The results of these trials are shown in FIG. 6.

The condensed milk product with nanobubbles exhibited a significantly reduced viscosity as compared with the control across all of the sheer rates tested. This difference was even more pronounced at the lower sheer rates tested. Accordingly, this example confirmed that introducing nanobubbles into a condensed milk product having a relatively high solids content was capable of significantly lowering the viscosity of the liquid across a range of sheer rates.

### Example 2

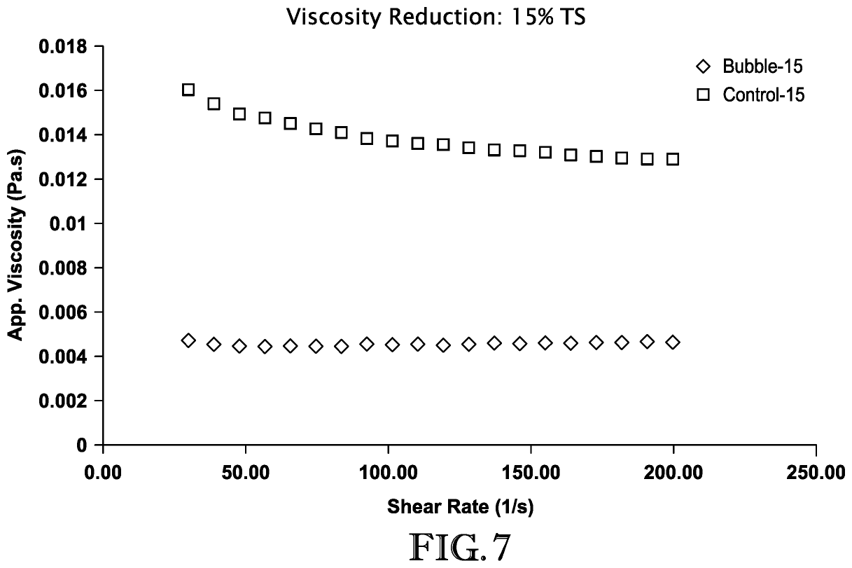

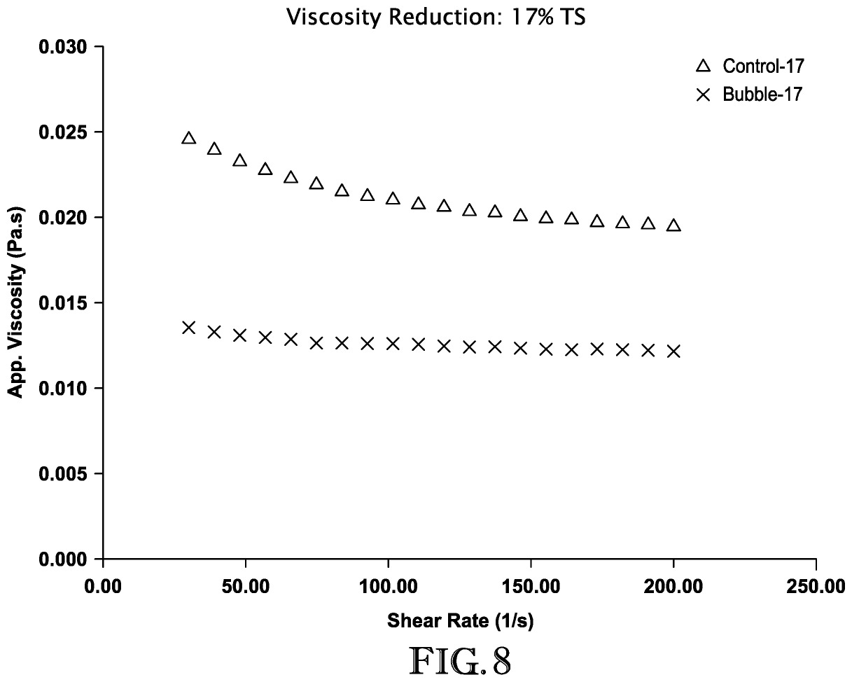

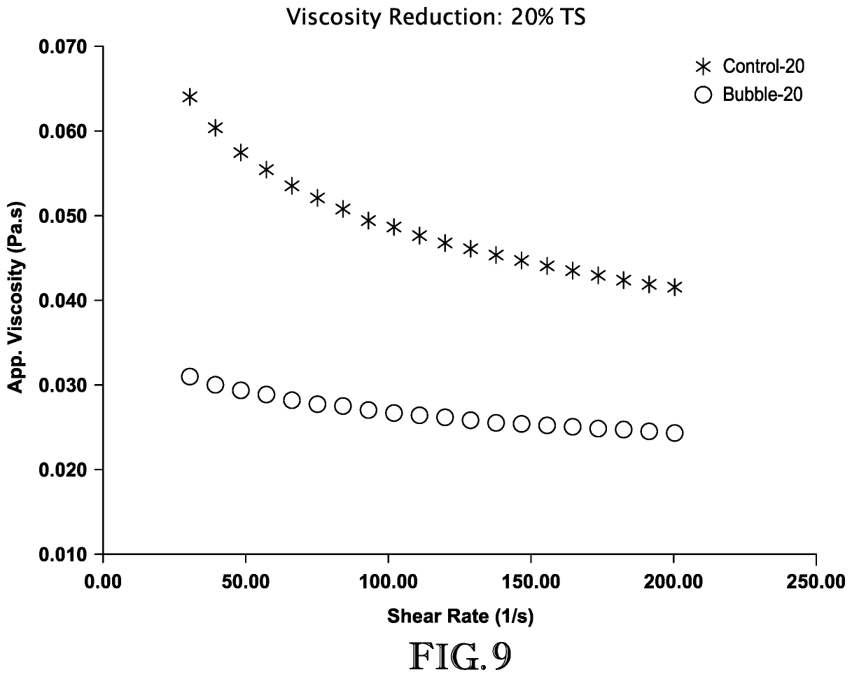

In this example, the effect of nanobubble introduction on viscosity of several milk protein concentrate solutions was tested. The tested solutions comprised total solids contents of 15%, 17% and 20% by weight. The nanobubbles were introduced into the milk solutions according to the procedure described in Example 1. Viscosity of the solutions with and without nanobubbles was tested using a stress controlled rheometer (ATS Rheosystems, NJ) at various sheer rates. The results are provided in FIGS. 7, 8, and 9, respectively. In all three cases, the milk product containing the nanobubbles exhibited much lower viscosities over the control samples.

### Example 3

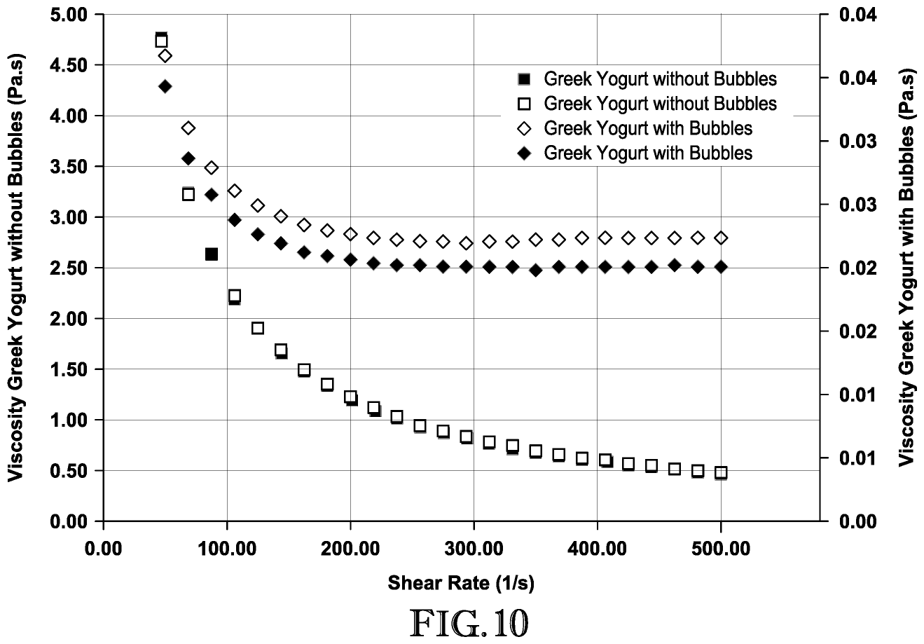

In this example, the effect of nanobubble introduction on viscosity of a Greek-style yogurt (containing approximately 10% protein) as well as a nonfat yogurt were tested. Greek-style yogurt traditionally is made by straining fermented yogurt in a cloth bag by centrifugation/membrane processing to reach the desired solids level by removing acid whey. The Greek-style yogurt may or may not contain additional thickening agents or additives. The nanobubbles were introduced into the tested yogurt products according to the procedure described in Example 1. The viscosity of the Greek-style yogurt with and without nanobubbles was tested using a stress controlled rheometer (ATS Rheosystems, NJ) at various shear rates (50-500 s⁻¹). The results obtained from Greek-style yogurt are provided in FIG. 10. The viscosity of micro- and nano-bubble containing Greek-style yogurt is consistently lower than the Greek style yogurt with no bubbles.

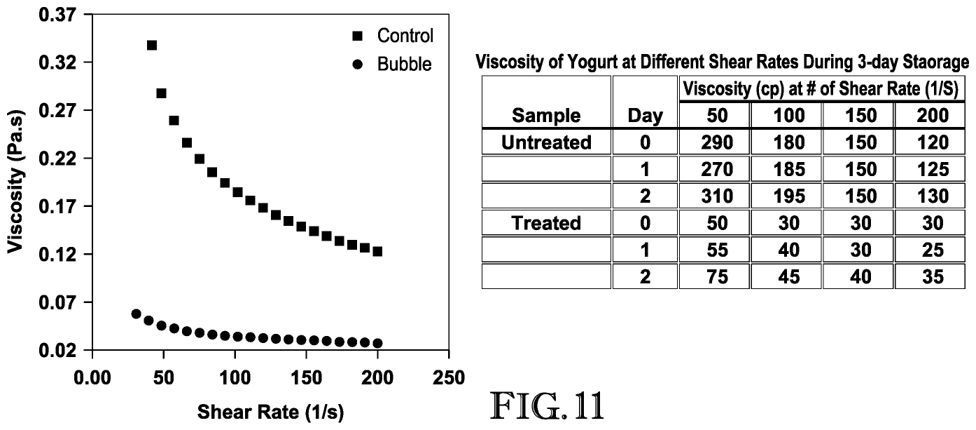

The results of the testing of the nonfat yogurt are shown in FIG. 11. Not only was the initial viscosity of the yogurt containing the nanobubbles lower than the untreated yogurt, the viscosity remained lower over the entire 3-day test period indicating the stability of the nanobubbles within the yogurt product.

### Example 4

In this example, pasteurized fresh skim milk was concentrated to a volume concentration factor of about 3.5 at 10° C. using a labscale membrane filtration system constructed in accordance with FIG. 12. The system was fitted with a 10 kDa cut-off polyethersulfone membrane at a constant transmembrane pressure of 30 psi with a flow rate of 1.8 L/min. A peristaltic pump (Masterflex I/P Tubing Pump, with Model 960-0000 pump head) and a KNF LIQUIPORT Diaphragm liquid transfer pump (Trenton, N.J.) were connected in series and an air injector was inserted between these two pumps. In the control trials, the injector was removed from the setup. The weight of the permeates was recorded in line at regular time intervals to calculate the change of the filtration flux. The air flow rate was controlled in the range 0.010-0.025 L/min. The results showed that the flux of the bubble-injected trials was always higher than the controls (no bubbles). The difference in flux was as high as 18%. Table 1 shows that higher total solids and total protein were achieved via bubble injection.

TABLE 1

| | | Bubbled/ | | |
|---|---|---|---|---|
| Trial | Sample | Control | Total Solids (%) | Total Protein (%) |
| Trial 1 | Retentate | Bubbled | 15.20 | 11.64 |
| | | Control | 14.50 | 10.90 |
| | Permeate | Bubbled | 4.20 | 0.18 |
| | | Control | 3.56 | 0.15 |
| Trial 2 | Retentate | Bubbled | 13.40 | 10.35 |
| | | Control | 12.77 | 8.82 |
| | Permeate | Bubbled | 4.20 | 0.12 |
| | | Control | 3.07 | 0.17 |

As shown in Table 2, ash and calcium are lower in the bubble injected retentates and higher in the bubble injected permeates. These results indicated that bubble injection leads to better removal of non-protein components from the milk system during ultrafiltration.

TABLE 2

| | Bubbled/ | | | |
|---|---|---|---|---|
| Sample | Control | Ash (%) | Calcium (mg/kg) | Lactose (%) |
| Retentates | Control | 1.75 ± 0.74 | 3461.2 ± 272 | — |
| | Bubbled | 1.03 ± 0.53 | 3454.4 ± 44 | — |
| Permeates | Control | 0.25 ± 0.05 | 257.4 ± 0.26 | 3.57 ± 0.06 |
| | Bubbled | 0.64 ± 0.25 | 268.4 ± 0.12 | 4.08 ± 0.07 |

### Example 5

In this example, spray drying apparatus constructed as illustrated in FIG. 13 was used to determine the effect of micro- and/or nanobubble introduction into a milk solution on the physical characteristics of the resulting milk powder. Milk solutions comprising 20 wt. % of reconstituted non-fat dry milk (NFDM) powder and milk protein concentrate (MPC 85) were prepared. The reconstitution was carried out at 40° C. for 30 min. Samples were kept at 4° C. overnight in order to ensure full hydration of the powders. Before spray drying, the reconstituted solutions were brought to room temperature. Micro- and/or nano-sized air bubbles were continuously injected into the reconstituted solutions prior to spray drying with controlled air flow rate 0.017 L/min. Control samples without bubble injection were also performed. Milk solutions were spray dried using an LPG-5 Centrifugal Spray Dryer (Jiangsu Fanqun Drying Equipment Factory, China), with inlet hot air temperature at 190° C. and flow rate of 92.7 ml/min.

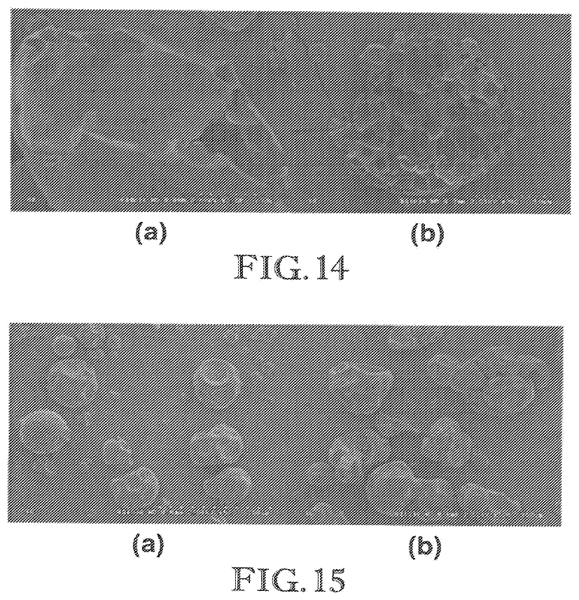

After spray drying, the collected powders were stored in a freezer at −20° C. before functionality tests were performed. The micro-structural difference of powders was examined using Hitachi S-3500N Scanning Electron Microscope (SEM) (Tokyo, Japan). As can be seen in FIG. 14, the spray-dried NFDM powder (a) and MPC 85 powder (b), having bubbles injected prior to spray drying, both exhibit a highly porous structure. This porous structure is noticeably absent from the control samples of NFDM powder (a) and MPC 85 powder (b) shown in FIG. 15.

Generally, milk protein concentrates exhibit low solubility and low dispersibility in water and require long hydration times, as evidenced during the preparation of the NFDM and MPC 85 samples. It is believed that the highly porous powders produced according to this embodiment of the present invention have improved rehydration characteristics. Moreover, the process for producing the highly porous powders of the present invention do not result in further denaturation of the milk proteins. Whey protein is one of the most, if not the most, temperature sensitive component present in milk. When heated, such as through the extrusion process disclosed by Bouvier et al., Dairy Sci. & Technol. (2013) 93:387-399, the whey protein denatures and can interact with casein thereby forming bonds with casein. Therefore, processes used to produce porosified milk protein powders using high heat, pressure and shear, will necessarily result in a greater degree of protein denaturation.

We claim:

1. A method of reducing the viscosity of a liquid carrying dissolved or suspended solid particles having an electrostatically charged surface comprising the step of introducing a plurality of gaseous bubbles into the liquid, the gaseous bubbles having an average diameter of less than 40 microns and induce an electrostatic charge in the interface between the liquid and gaseous bubbles that is of the same polarity as the electrostatic charge carried by the surface of the solid particles.

2. The method according to claim 1, wherein the liquid comprises a dairy product.

3. The method according to claim 2, wherein the dairy product comprises a member selected from the group consisting of milk, milk concentrates, and yogurt.

4. The method according to claim 1, wherein the solid particles comprise casein and/or whey proteins.

5. The method according to claim 1, wherein the solid particles comprise a negative electrostatic charge.

6. The method according to claim 1, wherein the bubbles induce a negative electrostatic charge in the interface between the liquid and gaseous bubbles.

7. The method according to claim 1, wherein the gaseous bubbles are introduced into the liquid until the liquid is saturated with the gaseous bubbles.

8. The method according to claim 1, wherein the gaseous bubbles have an average particle size of from about 100 nm to about 30 microns.

9. A method of concentrating a liquid dairy product comprising:
introducing a plurality of gaseous bubbles into the liquid dairy product, the gaseous bubbles having an average diameter of less than 40 microns; and
removing at least a portion of the water from the liquid dairy product so as to form a concentrated dairy product.

10. The method according to claim 9, wherein the liquid dairy product comprises a member selected from the group consisting of milk, milk concentrates, and yogurt.

11. The method according to claim 9, wherein the bubbles induce a negative electrostatic charge in the interface between the liquid dairy product and the gaseous bubbles.

12. The method according to claim 9, wherein the gaseous bubbles are introduced into the liquid dairy product until the liquid dairy product is saturated with the gaseous bubbles.

13. The method according to claim 9, wherein the gaseous bubbles have an average particle size of from about 100 nm to about 30 microns.

14. The method according to claim 9, wherein the concentrated dairy product comprises from about 40% to about 90% by weight water.

15. The method according to claim 9, wherein the step of removing at least a portion of the water from the liquid dairy product comprises heating the liquid dairy product within an evaporator.

16. The method according to claim 15, wherein the evaporator is located upstream from a spray dryer.

17. The method according to claim 16, wherein the concentrated dairy product is passed through the spray dryer so as to form a powdered dairy product.

18. The method according to claim 15, wherein the gaseous bubbles are introduced into the liquid dairy product prior to the liquid dairy product entering the evaporator.

19. The method according to claim 15, wherein the gaseous bubbles are introduced into the liquid dairy product within the evaporator.

20. The method according to claim 9, wherein the liquid dairy product comprises casein particles.

21. The method according to claim 20, wherein the gaseous bubbles induce an electrostatic charge in the interface between the liquid dairy product and gaseous bubbles that is of the same polarity as the electrostatic charge carried by the casein particles.

22. The method according to claim 9, wherein the step of removing at least a portion of the water from the liquid dairy product comprises passing the liquid dairy product through a membrane separation system.

23. The method according to claim 22, wherein the membrane separation unit comprises one or more ultrafiltration units.

24. The method according to claim 23, wherein the membrane separation system comprises at least one feed pump operable to deliver the liquid dairy product to at least gaseous bubble injector where the gaseous bubbles are introduced into the liquid dairy product, and at least one other pump located downstream from the bubble injector that is operable to deliver the liquid dairy product to the one or more ultrafiltration units.

25. The method according to claim 9, wherein the step of removing at least a portion of the water from the liquid dairy product comprises passing the liquid dairy product containing the plurality of gaseous bubbles through a spray dryer.

26. A dairy product infused with a plurality of gaseous bubbles having an average diameter of less than 40 microns.

27. The dairy product according to claim 26, wherein the dairy product comprises a member selected from the group consisting of milk, milk concentrates, and yogurt.

28. The dairy product according to claim 26, wherein the gaseous bubbles have an average particle size of from about 100 nm to about 30 microns.

29. The dairy product according to claim 26, wherein the dairy product is saturated with the gaseous bubbles.

30. The dairy product according to claim 26, wherein the dairy product comprises from about 40% to about 90% by weight water.

31. The dairy product according to claim 26, wherein the gaseous bubbles comprise a member selected from the group consisting of air, nitrogen, oxygen, carbon dioxide, and combinations thereof.

32. A concentrated milk protein powder formed by a process comprising the steps of
introducing a plurality of gaseous bubbles into a liquid dairy product, the gaseous bubbles having an average diameter of less than 40 microns; and
passing the liquid dairy product containing the plurality of gaseous bubbles through a spray dryer to form the concentrated milk protein powder.
